(19) United States
(12) Patent Application Publication
(10) Pub. No.: US 2007/0058295 A1
(43) Pub. Date: Mar. 15, 2007

(54) UFD on a ring

(75) Inventor: Menahem Lasser, Kohav Yair (IL)

Correspondence Address: DR. MARK FRIEDMAN LTD.;C/o Bill Polkinghorn, 9003 Florin Way, Upper Marlboro, MD, 20772, US

(73) Assignee: M-SYSTEMS FLASH DISK PIONEERS LTD.

(21) Appl. No.: 11/485,379

(22) Filed: Jul. 13, 2006

Related U.S. Application Data
(60) Provisional application No. 60/715,390, filed on Sep. 9, 2005.

(51) Int. Cl. G11B 5/74

(52) U.S. Cl. 360/131; 386/125

(57) ABSTRACT

The present invention discloses devices and methods for packaging a memory component, such as a UFD (i.e. a USB flash disk), as a ring, enabling the user to carry the UFD on his/her body. The present invention teaches a finger ring that has a UFD cover attached to the ring with the UFD being removable from the ring. The present invention also teaches a ring where the UFD is integrated into the body of the ring.

This patent application claims the benefit of U.S. Provisional Patent Application No. 60/715,390 filed Sep. 9, 2005.

### FIELD AND BACKGROUND OF THE INVENTION

The present invention relates to devices and methods for packaging a UFD (i.e. a USB flash disk) as a ring, enabling the user to carry the UFD on his/her body.

UFDs are well-known in the art as portable means for data storage. UFDs in the prior art are packaged in a variety of shapes and forms in order to make them convenient to carry and use. Typical examples include: a UFD on a key chain, a UFD on a necklace, a UFD in a writing pen, and a UFD as a card in a wallet.

Some applications of UFDs involve the storage of highly-sensitive data on the UFD, making the loss or theft of the UFD very costly and risky. All of the prior art packaging of UFDs suffer from a major disadvantage from the point of view of the risk of theft or loss. As the UFDs are easily separable from the carrier, the loss of such UFDs may not be noticed by the carrier at the time of loss.

It would be desirable, for applications where the loss of a UFD must be avoided, to have a way to carry a UFD closely secured to the body of the carrier.

### SUMMARY OF THE INVENTION

It is the purpose of the present invention to provide devices and methods for packaging a UFD (i.e. USB flash disk) as a ring, enabling the user to carry the UFD on his/her body. A finger ring is known to be an item that is continuously within the view and awareness of a carrier. Intentional theft or unintentional loss of a ring is typically unlikely.

For the purpose of clarity, the term “ring” is defined in this application to refer to a body ornament shaped to be secured directly to a user's body (as opposed to e.g. hanging from a necklace), and typically toroidal in shape. Common examples of such rings include finger rings, bracelets, ear rings and nose rings, with finger rings being preferred for the purposes of the present invention. The definition of ring, as set forth above, includes in its scope hair ornaments like barrettes, even though barrettes aren't typically toroidal in shape. The term “integral” is defined in this application to refer to a component that is structurally included in the ring to provide the ring with its function as a ring. Thus, if such an integral component were missing, the item would no longer be a ring.

Since a UFD typically is equipped with a protective cover that shields the connector and the electronics of the UFD, the present invention teaches two alternative embodiments: In one preferred embodiment, the cover is a structural part of the ring, and the UFD body is unplugged from the ring when the UFD is used.

In another preferred embodiment, the UFD is an integral structural part of the ring, and the cover is unplugged from the ring when the UFD is used. In this embodiment, the user has to either hold his/her finger near the USB socket while the UFD is in use, or to remove the ring from his/her finger.

As the name “DiskOnKey™” implies, it is known to carry a UFD on a user's person, for example on a keychain. Arguably, it then is obvious to carry a UFD in any manner that is commonly used to carry keys for opening locks. The present invention is innovative relative to such prior art methods because it would be impractical to open a lock using a key attached to a finger ring.

Therefore, according to the present invention, there is provided for the first time a data storage device including: (a) a memory component for storing data, the memory component having a connector for operationally connecting the memory component to a host device; (b) a ring for carrying the memory component; and (c) a cover for covering the connector.

Preferably, the cover is permanently attached to the ring.

Preferably, the memory component is a USB flash disk.

Preferably, the connector is a flat connector.

Preferably, the ring is a finger ring.

Preferably, the memory component is permanently attached to the ring.

More preferably, the memory component is an integral part of the ring.

Most preferably, the memory component is a USB flash disk.

Most preferably, the connector is a flat connector.

According to the present invention, there is provided for the first time a method for protecting data, the method including: (a) storing the data in a data storage device; (b) attaching a ring to the data storage device; and (c) wearing the ring on a user's body with the data storage device attached to the ring.

Preferably, the data storage device is permanently attached to the ring.

Preferably, the ring includes a cover, of the data storage device, that is permanently attached to the ring, for reversibly attaching the data storage device to the ring.

Preferably, the data storage device is a USB flash disk.

Preferably, the data storage device includes a flat connector.

Preferably, the step of wearing the ring includes wearing the ring on a user's finger.

These and further embodiments will be apparent from the detailed description and examples that follow.

### BRIEF DESCRIPTION OF THE DRAWINGS

The present invention is herein described, by way of example only, with reference to the accompanying drawings, wherein:

FIG. 1A is a schematic side view of a UFD on a ring, according to a preferred embodiment of the present invention;

FIG. 1B is a schematic front view of the UFD on a ring, shown in FIG. 1A, according to a preferred embodiment of the present invention;

FIG. 2A is a schematic side view of the ring of FIG. 1A after the UFD is unplugged from the ring, according to a preferred embodiment of the present invention;

FIG. 2B is a schematic side view of the UFD of FIG. 1A after the UFD is unplugged from the ring, according to a preferred embodiment of the present invention;

FIG. 3A is a schematic side view of an alternate UFD on a ring, according to another preferred embodiment of the present invention;

FIG. 3B is a schematic side view of the UFD of FIG. 3A after the cover is unplugged from the ring, according to another preferred embodiment of the present invention;

FIG. 4 is a schematic front view of a UFD on a ring, where the UFD is an integral part of the ring, with the cover of the ring removed, according to another preferred embodiment of the present invention.

### DESCRIPTION OF THE PREFERRED EMBODIMENTS

The present invention relates to devices and methods for packaging a UFD as a finger ring, enabling the user to carry the UFD on his/her finger. The principles and operation for packaging a UFD as a finger ring, according to the present invention, may be better understood with reference to the accompanying description and the drawings.

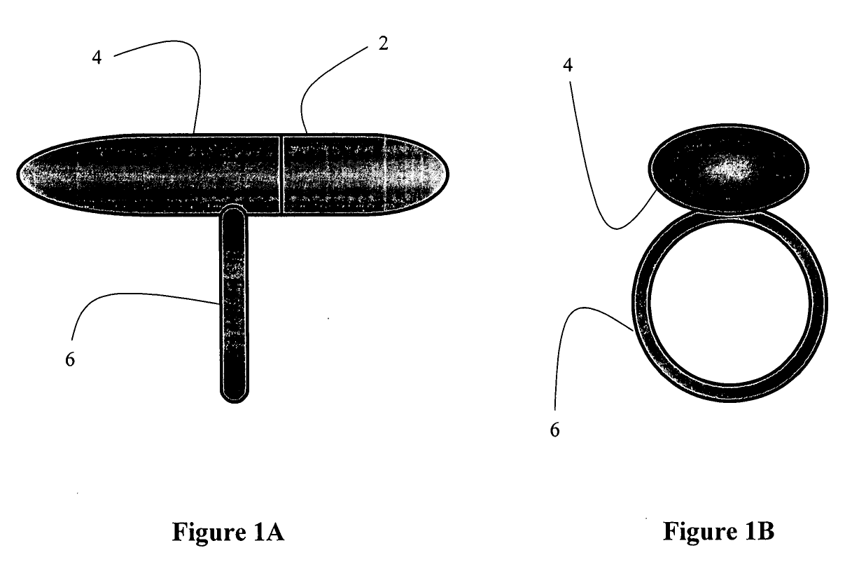

Referring now to the drawings, FIG. 1A is a schematic side view of a UFD on a ring, according to a preferred embodiment of the present invention. A UFD 2 is plugged into a UFD cover 4, where UFD cover 4 is permanently attached to a finger ring 6. UFD 2 can be any commercially available UFD, such as the DiskOnKey™ available from M-Systems Flash Disk Pioneers Ltd., Kefar Sava, Israel.

FIG. 1B is a schematic front view of the UFD on a ring, shown in FIG. 1A, according to a preferred embodiment of the present invention. UFD 2 and a finger ring 6 are shown as seen from the front.

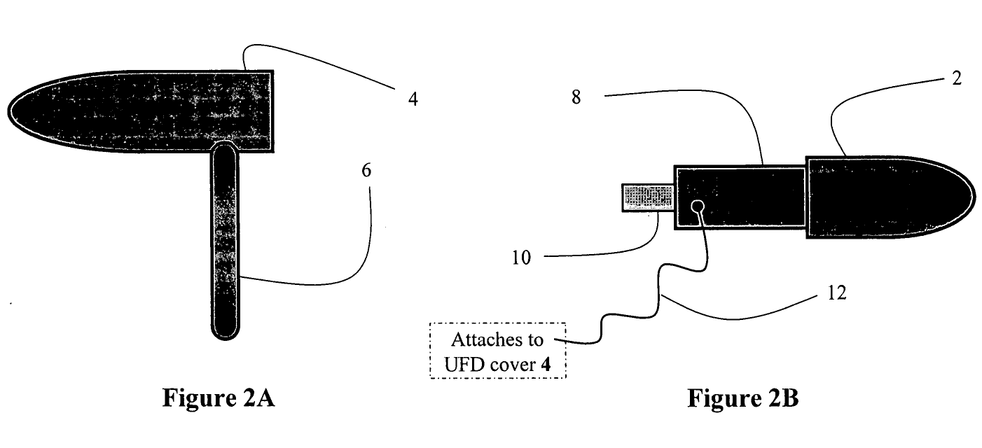

FIG. 2A is a schematic side view of the ring of FIG. 1A after the UFD is unplugged from the ring, according to a preferred embodiment of the present invention. UFD cover 4 is shown attached to finger ring 6, when the UFD (not shown) is removed for use. FIG. 2B is a schematic side view of the UFD of FIG. 1A after the UFD is unplugged from the ring. UFD 2 is shown with an electronics enclosure 8 and a USB connector 10 exposed, when UFD 2 is detached from UFD cover 4. In order to avoid UFD 2 being lost or stolen, UFD 2 and UFD cover 4 (shown in FIG. 2A) can be optionally connected by a string 12 that is stored inside UFD cover 4.

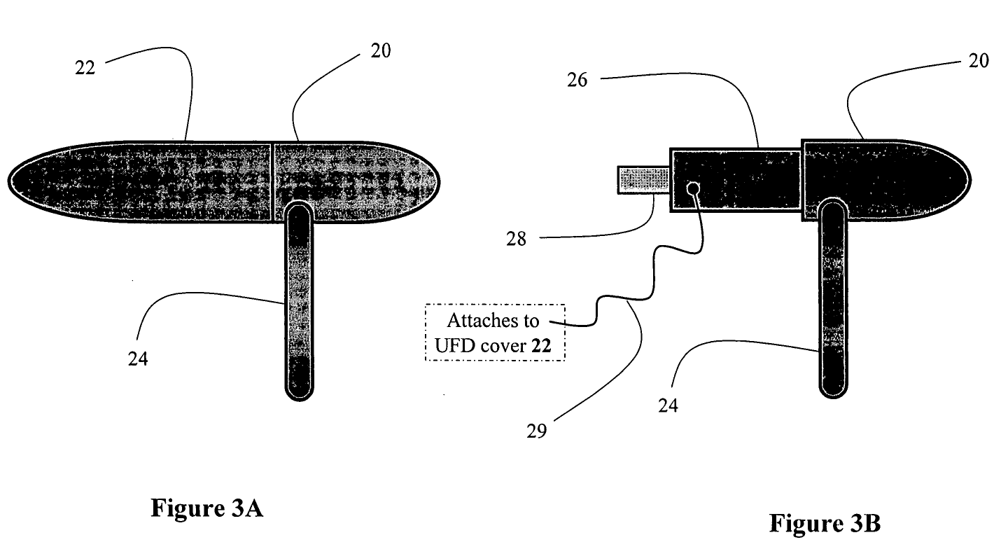

A slightly different embodiment, where the UFD is permanently attached to the finger ring, is shown in FIG. 3A. FIG. 3A is a schematic side view of an alternate UFD on a ring, according to another preferred embodiment of the present invention. A UFD 20 is plugged into a UFD cover 22, where UFD 20 is permanently attached to a finger ring 24. FIG. 3B is a schematic side view of the UFD of FIG. 3A after the cover is unplugged from the ring. UFD 20 is shown with an electronics enclosure 26 and a USB connector 28 exposed, when UFD cover 22 is detached from UFD 20. In order to avoid UFD cover 22 being lost or stolen, UFD 20 and UFD cover 22 (shown in FIG. 3A) can be optionally connected by a string 29 that is stored inside UFD cover 22.

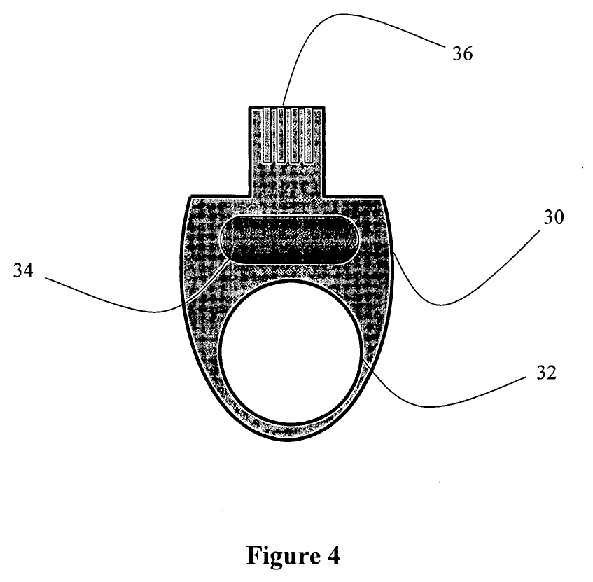

FIG. 4 is a schematic front view of a UFD on a ring, where the UFD is an integral part of the ring, with the cover of the ring removed, according to another preferred embodiment of the present invention. As shown in FIG. 4, a UFD 30 is included as an integral part of a finger ring 32. An electronics enclosure 34 and a USB connector 26 are shown as well. USB connector 36 can be a flat, bare USB connector as disclosed in U.S. patent application Ser. No. 11/304,746 filed Dec. 16, 2005, which is assigned to the assignee of the present invention, and is hereby incorporated by reference as if fully set forth herein. UFD 30 is typically protected by a UFD cover (not shown).

Clearly, the added feature of the present embodiment (shown in FIG. 4) is that in order to use UFD 30 as a computer peripheral the user must hold his/her finger close to a USB socket (not shown). This feature increases the security of finger ring 32 from theft or loss, since finger ring 32 never is removed from the user's finger during use. While this configuration may be awkward for the user if the host device (not shown) is far from the user's reach, connection of finger ring 32 can be made easier if the USB socket (not shown) is brought closer to the user via an extension cable (not shown). Then, the user is able to plug the cable socket (not shown) onto finger ring 32. Alternatively, the user may take finger ring 32 off his/her finger and plug USB connector 36 into the USB socket, in case the USB socket is inconveniently located.

While the invention has been described with respect to a limited number of embodiments, it will be appreciated that many variations, modifications, and other applications of the invention may be made.

What is claimed is:

1. A data storage device comprising:
(a) a memory component for storing data, said memory component having a connector for operationally connecting said memory component to a host device;
(b) a ring for carrying said memory component; and
(c) a cover for covering said connector.

2. The device of claim 1, wherein said cover is permanently attached to said ring.

3. The device of claim 1, wherein said memory component is a USB flash disk.

4. The device of claim 1, wherein said connector is a flat connector.

5. The device of claim 1, wherein said ring is a finger ring.

6. The device of claim 1, wherein said memory component is permanently attached to said ring.

7. The device of claim 6, wherein said memory component is an integral part of said ring.

8. The device of claim 7, wherein said memory component is a USB flash disk.

9. The device of claim 7, wherein said connector is a flat connector.

10. A method for protecting data, the method comprising:
(a) storing the data in a data storage device;
(b) attaching a ring to said data storage device; and
(c) wearing said ring on a user's body with said data storage device attached to said ring.

11. The method of claim 10, wherein said data storage device is permanently attached to said ring.

12. The method of claim 10, wherein said ring includes a cover, of said data storage device, that is permanently attached to said ring, for reversibly attaching said data storage device to said ring.

13. The method of claim 10, wherein said data storage device is a USB flash disk.

14. The method of claim 10, wherein said data storage device includes a flat connector.

15. The method of claim 10, wherein said step of wearing said ring includes wearing said ring on a user's finger.
